(19) United States
(12) Patent Application Publication
(10) Pub. No.: US 2012/0303137 A1
(43) Pub. Date: Nov. 29, 2012

(54) METHOD AND SYSTEM FOR CONTROLLING DEVICES AND/OR APPLIANCES BEING INSTALLED AND/OR IMPLEMENTED IN A USER NETWORK

(75) Inventors: Marcus Schoeller, Kronau (DE); Andreas Kunz, Heddesheim (DE); Hans-Joerg Kolbe, Darmstadt (DE)

(73) Assignee: NEC EUROPE LTD., Heidelberg (DE)

(21) Appl. No.: 13/520,224

(22) PCT Filed: Mar. 26, 2010
(86) PCT No.: PCT/EP2010/001939

§ 371 Date: Aug. 10, 2012

(30) Foreign Application Priority Data
Dec. 30, 2009 (EP) 09016117.5

(51) Int. Cl. G05B 15/00; G06F 1/26

(52) U.S. Cl. 700/1; 700/297

(57) ABSTRACT

A method for controlling devices and/or appliances being installed and/or implemented in a user network, includes the steps of providing a management application, and associating one or more UEs with the management application, providing location information of the associated UEs to the management application, and, based on the location information and configured policy rules, performing control actions on the devices and/or appliances. Furthermore, a corresponding system is described.

The present invention relates to a method and a system for controlling devices and/or appliances being installed and/or implemented in a user network.

Today, controlling home network devices and/or home appliances is predominantly done manually, e.g., by switching devices on and off with a physical power button. In a somewhat more sophisticated realization controlling is achieved by means of a management application. For instance, DigiControl Room 4D eControl by GFR Gesellschaft für Regelungstechnik and Energieeinsparung GmbH is a system solution for building management and building automation that allows users to log on from their PC to open windows, close the blinds, switch on lights or adjust the room temperature (see for reference http://www.gfr.de/gfr/start.asp?site=61001).

Another known way of controlling home network devices and/or home appliances is by means of static policies, e.g., a network may be regularly turned off between 12 am and 6 am every day.

However, all approaches existing so far are disadvantageous in that they lack a dynamic adaptation to changing usage behaviors and requirements. In particular in view of the steadily increasing demand for reducing power consumption, it is essential to operate home network devices, like e.g., PCs, laptops, or femtocells, as well as conventional home appliances, e.g. ovens, heating systems, washing machines or suchlike, in an economic way. For instance, it would be desirable to dynamically put these devices into a power saving mode, whenever they are not actively employed.

It is therefore an object of the present invention to improve and further develop a method and a system for controlling devices and/or appliances being installed and/or implemented in a user network in such a way that the control facilitates a dynamic adaptation to changing usage behaviors and requirements.

In accordance with the invention, the aforementioned object is accomplished by a method comprising the features of claim 1. According to this claim, such a method is characterized in the steps of providing a management application, and associating one or more UEs with said management application, providing location information of said associated UEs to said management application, and, based on said location information and configured policy rules, performing control actions on said devices and/or appliances.

Furthermore, the aforementioned object is accomplished by a system comprising the features of independent claim 13. According to this claim, such a system is characterized in that the system includes a management application, wherein one or more UEs are associated with said management application, and means for providing location information of said associated UEs to said management application, wherein said management application is configured to perform control actions on said devices and/or appliances based on said location information and configured policy rules.

According to the invention it has been recognized that dynamic adaptation to changing usage behaviors and requirements can be achieved on the basis of the location of a selected (group of) UE(s) which has/have been associated with a management application. This management application receives notifications about the location of the UEs. Based on this location information and a set of pre-defined policies control actions can be performed on the devices and/or appliances. By applying the present invention a maximum of energy savings can be achieved, since due to the dynamic adaptation dependent on the UE location devices and appliances only have to be fully energized when they are actually needed. At the same time the comfort for the user is increased, as no manual activity is required on the part of the user. The user only has to once specify the policy rules, after that the system can operate completely automatically.

It is to be noted that the term “UE” (User Equipment) employed herein is originally used in connection with UTRANs (UMTS Terrestrial Radio Access Networks) to denote user end devices. However, in this regard it is not intended to limit the scope of the present invention in any way. A skilled person will easily recognize that the method and the system according to the present invention are in no way limited to UTRAN, but can be applied in any other wireless communication architecture. Therefore, the term “UE” as employed herein shall generally denote any communication device that is operated by a user and that is equipped with means for performing wireless communication.

According to a preferred embodiment it may be provided that the location information is sent directly from the UEs to the management application. Alternatively, it may be provided that the location information is sent to the management application via the operator network of the UEs. In such case, within the operator network privacy setting mechanisms can be implemented for higher privacy levels of the users. More specifically, aggregation of location information can be performed in the operator network, wherein only the aggregated location information is forwarded to the management application. In particular in these cases where the operator network guarantees users' privacy by means of according privacy settings—with respect to forwarding location data to the management application—, the management application does not necessarily have to be under the control of the users themselves, but may be provided by a third-party provider.

In a specific embodiment the location information may include detailed geographical information about all of the associated UEs. However, in many application scenarios such fine grained location information is i) not necessary for the management application to perform suitable control actions, and ii) not acceptable in view of user privacy issues. Therefore, it may be provided that the location information includes only relative location information of the UEs with respect to the location of said user network. In many application scenarios it might even be sufficient to sent only relative location information of one single UE to the management application, in particular of the UE being located closest to the location of the user network.

Concerning an effective provision of reliable location information it may be provided that the UEs periodically measure the link quality to base stations in their vicinity. From these measurements the location of a UE can be deduced by comparing the base station identifiers of the measurements with the base station identifiers received at the location of said user network. Alternatively, location information may be provided by deployment of existing positioning system, like e.g. GPS (Global Positioning System).

In a specific embodiment the management application may send control commands directly to the devices and/or appliances under control. According notifications may be sent to the UEs in order to inform the associated users of the actions that have been performed. To keep the overhead as low as possible, it may be provided that the notification is not sent to all associated UEs, but only to a single one, in particular to a UE that the associated users have specified as master UE. For instance, in a family household control scenario, the UEs of the parents may be specified as master UEs over the UEs of the children. Furthermore, before sending any control commands to the devices and/or appliances under control, the management application may send feedback requests to at least one of the associated UEs, which again may be the master UE. In such case, control commands are given by the management application only upon explicit acknowledgment from the UE(s).

Advantageously, the management application includes a policy manager that associates specific location events with dedicated control actions. By this means it is possible to trigger certain control actions dependent on the occurrence of certain location events monitored by the UEs or within the operator network. For instance, a safety management application can warn the user about potential hazardous situations, e.g., someone turned on the oven and left the premises. In this case “leaving the premises” would constitute a location event, and “turning the oven off” would be the associated control action autonomously carried out by the management application.

In a preferred embodiment, the devices and/or appliances being installed and/or implemented in the user network may be operated under the control of a home controller. In such case the devices and/or appliances would not have to visible to the outside, i.e. to the management application. The home controller may be configured to check the status of the devices and/or appliances under control, which communicate their operational state to the home controller on a regular basis.

With respect to a particularly high user comfort, the home controller may include a local policy manager for implementing local control policies for the devices and/or appliances. The local control policies allow customization for different scenarios and user groups and may be defined by the users themselves according to their individual needs and requirements. Based on the user defined policies the home controller issues commands to the devices/appliances under control, e.g., automatically turn on an alarm if all UEs are more than 50 km away from the User network. Moreover, the home controller may send a respective notification about the action to one or more of the UEs. Alternatively, the home controller may request an explicit acknowledgment from the user/UE for the action to be taken, e.g., should the oven be turned off. In this regard the associated users may specify that certain actions require an acknowledgment from all associated users, whereas for other actions to be executed an acknowledgment of a single UE (a specific one, as the case may be) is considered sufficient.

In a concrete application scenario the management application may be configured to send a command to said home controller to put the devices and/or appliances being installed and/or implemented in the user network into a power save mode in case all UEs associated with said user network are outside a pre-defined area around said user network. For instance, this implementation may be realized in cases in which the device being controlled is a femtocell, wherein one or more UEs are authorized to connect to the femtocell. Femtocells are often deployed to increase the capacity at the cell edge of the macro network. One implementation is a closed subscriber group access control which means that only authorized UEs are allowed to connect to a femtocell. As an authorized UE can be handed over to the femtocell at any time, in prior art systems the femtocell must be empowered at all times. However, keeping the femtocell permanently operational consumes power even if no UE is currently attached to the femtocell and the associated UEs cannot request services. Applying the method according to the present invention allows switching off the femtocell (or at least parts thereof) in case all associated UEs have left the area of the femtocell, thereby reducing the radio-pollution in this area and the power consumption of the femtocell. Activation of the femtocell dynamically as needed by the UEs' authorized to attach to the femtocell may be triggered when an UE comes back into the area of the femtocell.

There are several ways how to design and further develop the teaching of the present invention in an advantageous way. To this end, it is to be referred to the patent claims subordinate to independent patent claims 1 and 13 on the one hand, and to the following explanation of a preferred example of an embodiment of the invention illustrated by the drawing on the other hand. In connection with the explanation of the preferred example of an embodiment of the invention by the aid of the drawing, generally preferred embodiments and further developments of the teaching will be explained. In the drawings

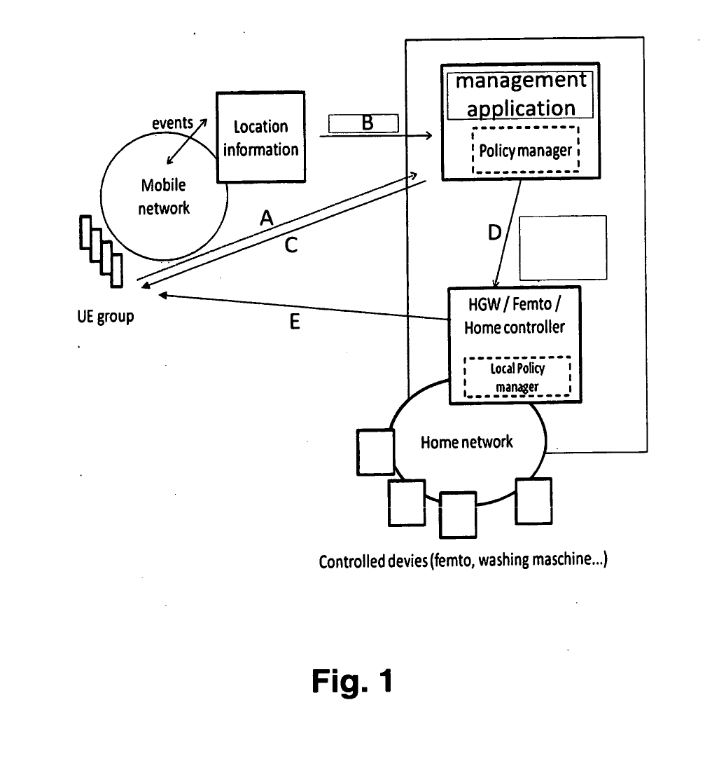

FIG. 1 schematically illustrates an embodiment of a system according to the present invention with UE location based control of home devices and appliances, and

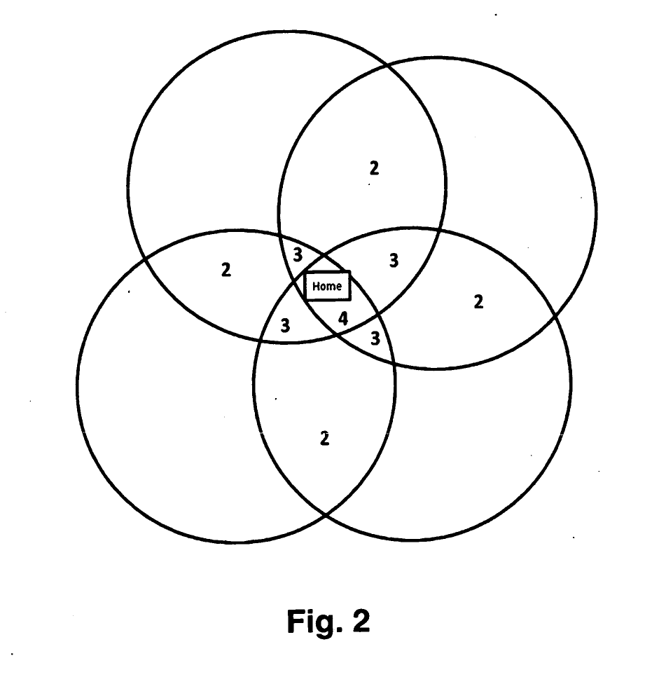

FIG. 2 schematically illustrates exemplary measurement results of a specific method for deriving UE location information.

The present invention allows the control of home network devices and appliances, e.g., an alarm/notification system, based on relative UE locations. Examples for such an alarm/notification system include but are not limited to the following examples: An alarm can be sent to one or more UEs if an oven is still on, but all terminals left the premises, or a notification can be sent to the parents UE if the kids leave school or enter the house. Which actions to take are controlled by policies defined by the users of the UEs. These policies are managed by a policy entity which receives and aggregates the location information of the subscribed UEs and issues commands to the appropriate devices directly or requests feedback from one or more associated devices. To continue the above example, the system can ask the terminals if the oven should be switched off (assuming the appliance allows such remote controlling). An adult who just picks up the child from school preparing lunch will reject such a request whereas an adult on his way to work will acknowledge the remote turn off of the oven.

Referring now to FIG. 1, a system is illustrated for UE location based control of home devices and appliances according to an embodiment of the present invention. A selected group of UEs have been associated with a management application. This group of UEs might include, for example, the UEs of all family members or denizens in case of e.g. a home management application scenario, or UEs of a closed subscriber group in case of e.g. controlling a femtocell. The management application receives notifications about the relative location of the UEs. This information can be sent directly from the UEs to the application (as indicated by arrow denoted A) or via the operator's network (indicated by arrow B). Within the operator's network aggregation of location information can be performed for higher privacy levels.

In the following the two different modes of operation are summarized:

1. UE Based Only Mode:

This mode implements the step of deriving location information of UEs and sending them to the management application solely on the UE(s). The UE(s) send their location update message directly to the management application. In order to derive the control actions to be taken, the management application may compare the relative location of all UEs associated with this application.

2. Operator Assisted Mode:

In this mode the UEs do not send the location information to the management application directly, but to an application within the operator's network. This application compares the location information of the UEs and aggregates it according to the management application requirements, e.g., only sending the relative location information of the closest UE to the management application. This allows the provisioning of control applications by third-party application providers while adhering to data privacy laws and even reaching higher privacy demands of users. The location information granularity can be adjusted to any desired level which serves the application requirements. The application within the operator's network can derive the exact geographical location of the UEs, translate this into relative location information and send only a sub-set of this information to the management application.

The management application can be implemented at the site of the user network. Alternatively, as only relative location information has to be sent to the management application, it can be provided by third-party application providers, preserving privacy rights of the users. Different implementations with varying privacy levels are possible. One extreme is to send detailed geographical information of all UEs to the application. The other extreme is to sent only relative location information of one UE to the application, e.g., the closest UE is 5 km away from the reference location.

The management application includes a policy manager for associating specific location events with dedicated control actions. Based on the relative location information and a set of pre-defined policies specified in the policy manager, the management application sends control commands to applications and devices of the user (not shown in FIG. 1) and/or sends a notification or feedback request to the associated user(s) (arrow C).

A home controller in the user's network can implement local policies to implement more fine-grained control mechanisms. For instance, in case of .the management application being a home safety application, this application will constantly monitor the UEs location. If the UEs leave the home location, a notification is sent to the home controller (arrow D). This notification may be sent, for example, by making use of TR-69, being the communication protocol which is predominately employed for the configuration and management of HGWs (home gateways). Alternatively, SNMP (Simple Network Management Protocol) or the SIP/HRACS (???) protocol may be employed. The home controller checks the status of pre-defined appliances, e.g., oven, house alarm, etc. This assumes that the home appliances can communicate their status to the home controller but are not visible to the outside and can therefore not be controlled directly by the home safety application. Based on the user defined policies the home controller issues commands to these appliances, e.g., automatically turn on alarm if all UEs are more than 50 km away and send a notification about the action to the UEs. Alternatively, the home controller requests an acknowledgment from the user/UE for the action to be taken (arrow E), e.g., should the oven be turned off? Upon receiving an acknowledgment requests, the user can provide according feedback via his UE to perform an action like turning off the oven remotely.

The described system exceeds the current state of the art for location based services as it allows for control commands to be sent to arbitrary devices based on the location of one or more UEs, integrates a policy driven behavior into the method, enables feedback control loops with the user making the UE a central control device, and is open for third party application for home control functions.

Basically, the location monitoring can be measurement based, e.g. identification of base stations in the UE's and the home network's vicinity, GPS based or based any other technology allowing for a sufficiently detailed UE localization. FIG. 2 illustrates a specific measurement based example in some more detail. According to this example, a UE periodically measures the link quality to the base stations in its vicinity. As is common, these base stations are uniquely identified. An application on the UE or within the operator network can deduce the location of the terminal by comparing the base stations identifiers of the current measurements with the base station identifiers at the reference location, e.g., home, office, school.

As an example, depicted in FIG. 2, four base stations—hereinafter called the home BST group—can be monitored at the home location, i.e. the location of the home network. If the user (together with his UE) leaves home, but stays relatively close to his home, the UE receives radio signals from all four base stations. While moving further away from home, the number of monitored base stations of the home BST group decreases. An application specific configuration specifies when the terminal has moved away from home far enough to trigger a location information update to the management application. An example configuration can define that three out four monitored BSTs of the home BST group are still treated as the home location, whereas two or fewer BSTs out of these four monitored base station of the home BST group trigger an update. On the reverse, as the user approaches the home location, the application will trigger an update when three out of the four base stations of the home BST group can be monitored again.

The location update message sent to the management application contains only the information that the area around the home location has been left or entered, respectively, without giving any more details about the exact location. Different metrics for relative location information can be utilized. The granularity of information depends on the application requirements and the privacy settings of the users. Preferable metrics are distance in km from the reference location or number of base stations heard from the base station home group as describe above. Whereas the distance metric is well defined in any deployment, the base station overlap metric has an inherent uncertainty as the cell size of base stations varies a lot in different deployment areas and for different technologies.

In the following different application scenarios and example embodiments of the present invention are described in some more detail:

1. Application for UE Location Directed Power Management of Home Network Devices

A management application being designed as power management application is informed about the geographical location of a group a mobile terminals which are associated with a home network. If all associated UEs are outside the pre-defined area around the home, the management application policy server sends a command to the home controller to put network devices, e.g., femto cells, home gateway, etc., into power save mode. A wake-up command is sent to the home controller if an UE is entering the pre-defined area around the home again. This command requests network devices to get back into full operational mode.

2. Application for Appliance Control with User Notification

A management application being designed as home control application can set the heating system on vacation mode when all UEs moved away from the house and stay at the remote location for some days. A notification is sent to all UEs to inform the users about the changed settings. As soon as the UEs move into the home direction, e.g. covering half the distance between the remote location and home, the heating system is set to normal mode giving the users a comfortable welcome on their return. Again a notification is sent to the UEs to inform the users.

3. Application for Appliance Control with User Feedback

A management application being designed as home safety application monitors the UEs location. If the UEs leave the home location a notification is sent to the home controller. The home controller checks the status of pre-defined appliances, e.g., oven, house alarm, etc. This assumes that the home appliances can communicate their status to the home controller but are not visible to the outside and can therefore not be controlled directly by the home safety application. Based on the user defined policies the home controller issues commands to these appliances, e.g., automatically turn on alarm if all UEs are more than 50 km away and send a notification about the action to the UEs. Alternatively, the home controller requests an acknowledgment from the user/UE for the action to be taken, e.g., should the oven be turned off?

4. Application for UE Location Notification

The UEs of children send location information to a child supervision application. This application sends a notification message to the parent UEs if the kids split up, going in different directions, or leaves a certain location, e.g., school, playground, grandparent's house.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-19. (canceled)

20. Method for controlling devices and/or appliances being installed and/or implemented in a user network, which comprises the steps of:
providing a management application, and associating one or more UEs with said management application;
providing location information of said associated UEs to said management application; and
based on said location information and configured policy rules, performing control actions on said devices and/or appliances.

21. Method according to claim 20, wherein said location information is sent directly from said UEs to said management application.

22. Method according to claim 20, wherein said location information is sent to said management application via the operator network of said UEs.

23. Method according to claim 22, wherein an aggregation of said location information is performed in said operator network, and wherein the aggregated location information is forwarded to said management application.

24. Method according to claim 20, wherein said location information includes detailed geographical information about all of said associated UEs.

25. Method according to claim 20, wherein said location information includes only relative location information of said UEs with respect to the location of said user network.

26. Method according to claim 20, wherein said location information includes only relative location information of one single of said associated UEs, in particular of the UE being located closest to the location of said user network.

27. Method according to claim 20, wherein said UEs periodically measure the link quality to base stations in their vicinity, and wherein the location of a UE is deduced by comparing the base station identifiers of the measurements with the base station identifiers received at the location of said user network.

28. Method according to claim 20, wherein said management application sends control commands directly to said devices and/or appliances.

29. Method according to claim 20, wherein said management application sends notifications and/or feedback requests to at least one of said associated UEs, in particular to a master UE.

30. Method according to claim 20, wherein said devices and/or appliances being installed and/or implemented in said user network are operated under the control of a home controller.

31. Method according to claim 30, wherein said home controller includes a local policy manager for implementing local control policies for said devices and/or appliances.

32. System for controlling devices and/or appliances being installed and/or implemented in a user network, in particular for execution of a method according to claim 20, the system including:
a management application, wherein one or more UEs are associated with said management application, and
means for providing location information of said associated UEs to said management application,
wherein said management application is configured to perform control actions on said devices and/or appliances based on said location information and configured policy rules.

33. System according to claim 32, wherein said management application is provided by a third-party provider.

34. System according to claim 32, wherein said management application includes a policy manager that associates specific location events with dedicated control actions.

35. System according to claim 32, wherein said devices and/or appliances being installed and/or implemented in said user network are operated under the control of a home controller.

36. System according to claim 35, wherein said home controller includes a local policy manager for implementing local control policies for said devices and/or appliances.

37. System according to claim 35, wherein said management application is configured to send a command to said home controller to put said devices and/or appliances being installed and/or implemented in said user network into a power save mode in case all UEs associated with said user network are outside a pre-defined area around said user network.

38. System according to claim 32, wherein said device being controlled is a femtocell, wherein said one or more UEs are authorized to connect to said femtocell.

39. System according to claim 33, wherein said management application includes a policy manager that associates specific location events with dedicated control actions.
